(19) United States
(12) Patent Application Publication
(10) Pub. No.: US 2009/0248643 A1
(43) Pub. Date: Oct. 1, 2009

(54) CRIME INFORMATION COORDINATION SYSTEM AND METHOD

(76) Inventor: Leon F. Wasson, Kissimmee, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/412,353

(22) Filed: Mar. 26, 2009

Related U.S. Application Data
(60) Provisional application No. 61/039,467, filed on Mar. 26, 2008.

(51) Int. Cl. G06F 17/30

(52) U.S. Cl. 707/3; 707/104.1; 707/E17.108; 707/E17.02

(57) ABSTRACT

Entities with crime media content, such as closed circuit television videos of crimes being committed, upload the crime media content to a network based crime information coordination system. The entities are prompted to select appropriate data tags for the uploaded crime media content, which are associated with the crime media content in crime incident data files generated and stored by the system. Entities who may have information about crimes search the stored crime incident data files over the network. The system displays selected crime incident data files, including the crime media content, to the entities and receives crime tip data therefrom.

### CROSS REFERENCE TO RELATED APPLICATION

This application claims the benefit of U.S. Provisional Application Ser. No. 61/039,467, filed on Mar. 26, 2008, the contents of which are hereby incorporated by reference in their entirety.

### FIELD OF THE INVENTION

The present invention relates to technology employed to facilitate crime solving, and more particularly, to network-based systems and methods for apprehending perpetrators.

### SUMMARY OF THE INVENTION

Media content including evidence relating to a crime, such as security camera video and/or still footage, audio recordings, police artist sketches, is very frequently created. While such media content may be reviewed by law enforcement authorities, or broadcast for a limited time on television or other news media, the media content is generally inaccessible to the public, at large. Thus, such media content, as well as the knowledge residing in the general public, is seriously underutilized to the corresponding crimes and apprehend perpetrators.

Based on the foregoing, it is an object of the present invention to improve the utilization of crime media content for solving crimes and apprehending perpetrators. According to an embodiment of the present invention, a network-based crime information coordination system includes a server having a processor and machine readable memory. The server executes a crime data file generation module configured to receive crime incident media content over the network from crime reporting entities and generate crime incident data files by associating the media content with crime data tags, a crime incident database storing the crime incident data files, and a crime data search module configured to receive crime data search requests over the network from crime researching entities and selectively display the crime incident data files from the crime incident database based on the crime data search requests.

According to a method aspect of the present invention, a network-based crime information coordination method includes receiving crime incident media content over the network from crime reporting entities and receiving crime data tag selections corresponding to the crime incident media content over the network from the crime reporting entities. Crime incident data files are generated including the crime incident media content and the corresponding crime data tags, and stored in a crime incident database searchable over the network by crime researching entities.

According to a further method aspect of the present invention, a network-based crime information coordination method includes maintaining a crime incident database of crime incident data files including crime data tags and crime media content and receiving crime data search requests corresponding to the crime data tags over the network from crime researching entities. Crime media content from crime incident data files corresponding to the crime data search requests is displayed to the crime researching entities over the network. Crime tip data relating to the displayed media content is received from the crime researching entities over the network.

These and other objects, aspects and advantages of the present invention will be better appreciated in view of the drawings and following detailed description of a preferred embodiment.

### BRIEF DESCRIPTION OF THE DRAWINGS

FIG. 1 is an schematic overview of a network-based crime information coordination system, including a server, according to an embodiment of the present invention;

FIG. 2 is an organizational diagram of the server of FIG. 1:

FIG. 3 is a flow diagram of operation of the system of FIG. 1;

FIG. 4 is an exemplary screen view displayed by the system of FIG. 1;

FIG. 5 is a continuation of the flow diagram of FIG. 3; and

FIG. 6 is another exemplary screen view displayed by the system of FIG. 1.

### DETAILED DESCRIPTION OF A PREFERRED EMBODIMENT

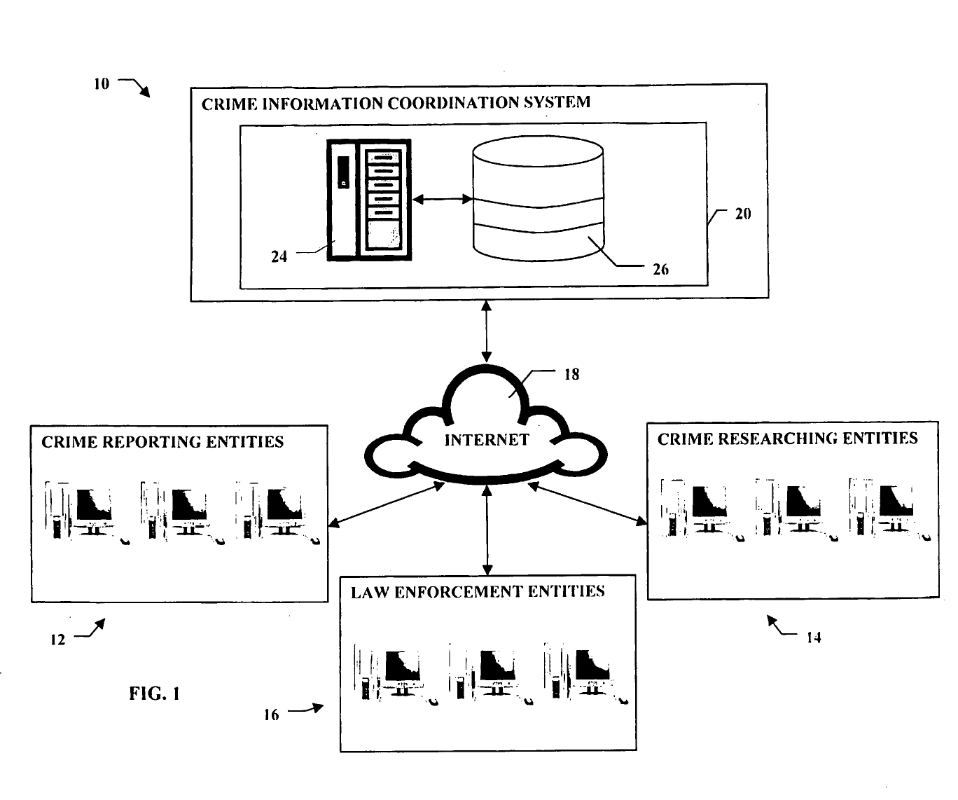

Referring to FIG. 1, a network-based crime information coordination system 10 is in communication with a plurality of crime reporting entities 12, crime researching entities 14 and law enforcement entities 16 via a network 18, such as the Internet. The system 10 includes a server 20 having a processor 24 and machine readable memory 26. It will be appreciated that the present invention is not necessarily limited to particular processor types, numbers or designs, to particular code formats or languages, or to particular hardware or software memory media. Additionally, the various components of the system 10 can, themselves, be located remotely from one another and communicate over one or more networks.

The crime reporting entities 12 can include, advantageously, retail chain operators, gas station chain operators, wholesale outlet operations, and the like, but can include any entities having media content relating to crimes. For instance, individuals, government agencies, religious institutions and educational institutions could also be crime reporting entities.

The crime researching entities 14 can include, advantageously, any member of the general public having access to the network 18, but can also include government agencies and other organizations. The law enforcement entities 16 include, advantageously, federal, state and local law enforcement agencies.

It will be appreciated a particular entity can be a member of more than one of the groups of entities 12-16. For example, a law enforcement agency could alternately interact with the system 10 as a crime reporting entity 12, a crime researching entity 14 and a law enforcement entity 16.

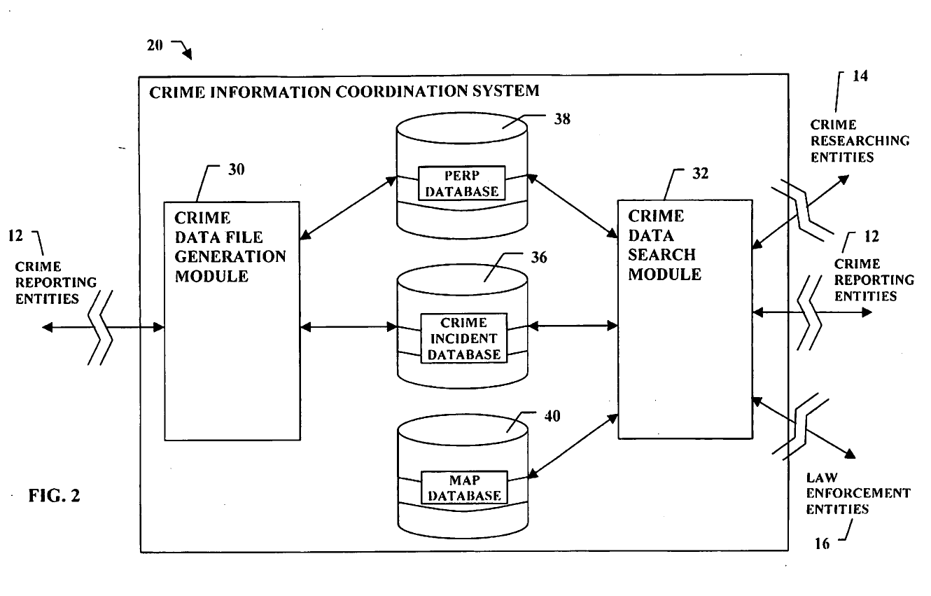

Referring to FIG. 2, the server 20 is configured to execute a crime data file generation module 30 and a crime data search module 32, as well as a crime incident, perpetrator and map databases 36-40. The crime data file generation module 30 receives inputs from the crime reporting entities 12 and outputs crime incident data files and perpetrator data files that are stored, respectively, in the crime incident and perpetrator databases 36, 38. The crime data file generation module 32 receives inputs from the crime reporting entities 12, accesses the crime incident, perpetrator and map databases 36-40, and generated outputs to the crime reporting entities 12, crime researching entities 14 and law enforcement entities 16.

The crime data file generation module 30 receives crime incident media content and perpetrator information data from the crime reporting entities 12. Based on further input from the crime reporting entities 12, the crime data file generation module 30 associates data tags with the media content and perpetrator information data, and generates the crime incident and perpetrator data files based thereon.

The crime data search module 32 receives search requests from the crime reporting entities 12, and based on the search requests, displays corresponding crime incident data files and perpetrator data files from the crime incident and perpetrator databases 36, 38 to the crime researching entities 14. Additionally, the crime data search module 32 displays crime incident location information in map form to the crime reporting entities 12 using data from the crime incident and map databases 36, 40.

The crime data search module 32 also accepts crime tip data from the crime reporting entities 12, if the crime reporting entities 12 have any information relating to viewed crime incident data files and perpetrator data files. The crime data search module 32 communicates the crime tip data to the crime reporting entities 12 associated with the corresponding crime incident data files, as well as to any law enforcement entities 16 with jurisdiction over the crime or perpetrator.

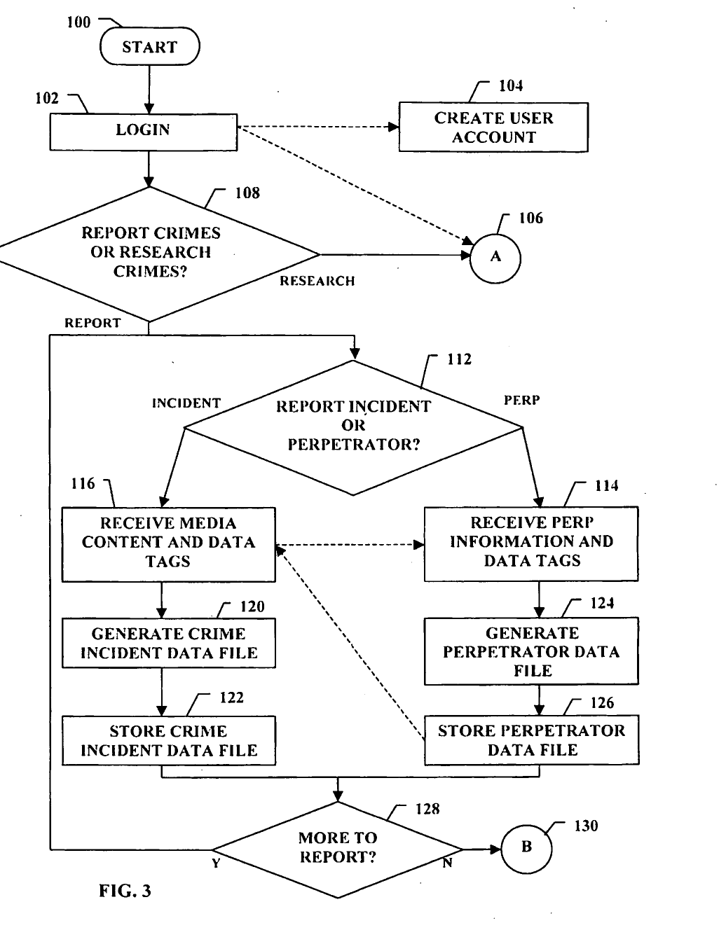

Referring to FIG. 3, operation of the system 10 starts at block 100. At block 102, a user accessing the server 20 (see FIG. 1) is prompted to login. If the user does not yet have an account to access the server, the user is allowed to create a new user account (block 104). Alternately, the user can opt to perform crime research anonymously without logging in, in which case the method proceeds to block 106.

Upon logging in, the system 10 determined whether the user intends to report crimes or research crimes (block 108). If the user intends to research crimes, the user interacts with the system as a crime researching entity 14, and the method proceeds to block 106. If the user intends to report crimes, the method proceeds to block 112 and the user interacts with the system as a crime reporting entity 12.

At block 112, the system 10 determines whether the user intends to report information about a crime incident or about a perpetrator. If the user intends to report information about a crime perpetrator, the method proceeds to block 114. If the user intends to report information about a crime incident, the method proceeds to block 116.

At block 116, the system 10 receives crime media content from the user, and based on user inputs, associates crime data tags with the crime media content. Crime media content can include any type of digital video, audio and/or picture format, such as security camera videos, stills and police artist sketches. In addition to uploading crime media content for a new incident, the user can also previously entered crime incident data files generated by the user, and edit or delete them.

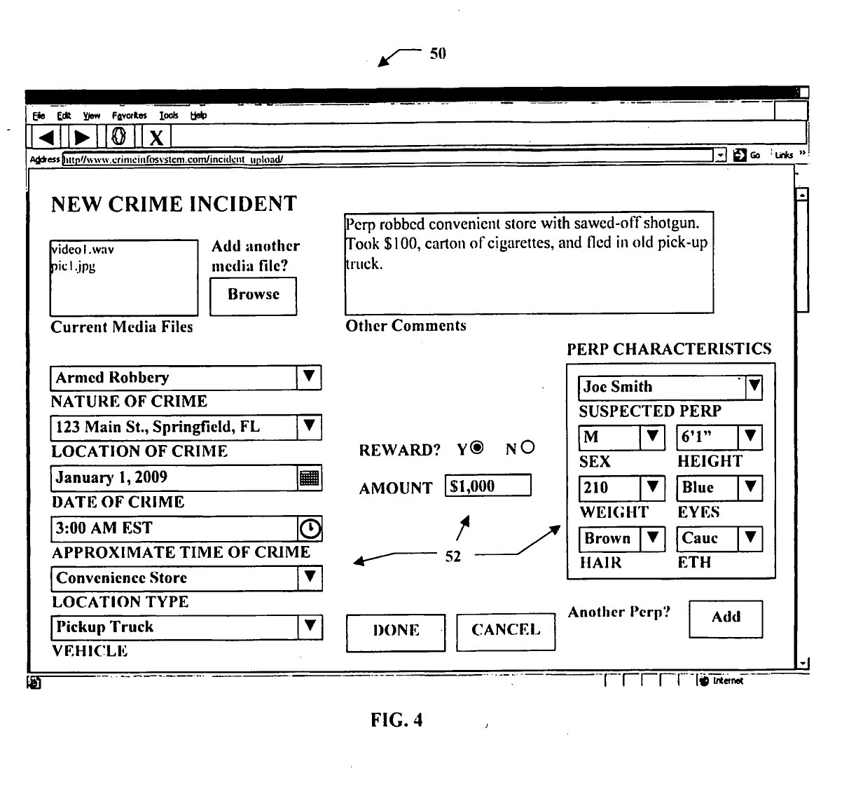

Referring to FIG. 4, in an exemplary crime incident data entry screen 50, the system 10 allows the user to upload a plurality of media files and additionally displays a plurality of predetermined crime data tag options 52 to the user. The system then generates crime data tags to associate with the crime media content based on user's selections from among the options 52.

The crime data tag options 52 advantageously include: nature of crime, location of crime, date of crime, time of crime, crime location type, crime vehicle type, perpetrator characteristics and reward information. Drop down menus are included to supply standardized selections from each of the options 52. For options 52 involving dates and times, calendar and clock pop-ups are supplied. The user is not necessarily required to make a selection for each option 52; however, selections for some options can be required. For example, the user can be required to select the location of the crime and the date of the crime.

The option selections 52 in drop down menus can include branching options. For instance, upon selecting “Assault” under “NATURE OF CRIME”, the user can be displayed a modified selection of “Assault—with a deadly weapon.”

Pre-entered user data associated with the user's account can be used to generate selections for the options 52. For example, the location of crime can include user locations entered in connection with the user's account. The user then need only select from one or more pre-entered locations in a drop down menu, such as retail store locations, rather than re-enter an address multiple times. An “Other Location” selection can be supplied in addition to pre-entered locations to allow the user to manually input a new location.

For “PERP CHARACTERISTICS”, the user can either individually enter physical characteristics for one or more perpetrators of unknown identity(ies). If the identity of a perpetrator is known, the user can also identity the perpetrator by name by selecting the name from a drop down list of known perpetrators in the perpetrator database 38. The physical characteristics for that perpetrator are then automatically entered based on the perpetrator data file for that perpetrator. An “Other Perpetrator” selection can be supplied to allow the user to manually input a new perpetrator, in which case the method shifts to block 114 to receive the information on the new perpetrator (see FIG. 3). The method then returns to block 116 after a data file for the new perpetrator is generated and stored.

Referring again to FIG. 4, the user is allowed indicate whether a reward is offered. If a reward is offered, the user enters a reward amount. Additionally, the user can freely enter other comments in a text box supplied for that purpose.

Referring again to FIG. 3, when the user is done uploading crime media content and selecting crime data tag options, the system 10 generates a crime incident data file including the crime media content and the crime data tags (block 120). At block 122, the crime incident data file is stored in the crime incident database 36.

If the user intends to enter information about a perpetrator, the user is allowed enter the perpetrator information. A screen is displayed to the user with perpetrator data tag options similar to the perpetrator characteristics of FIG. 4. The user is able to freely enter the perpetrators name and selects other perpetrator characteristics from drop down menus. Advantageously, the user can upload media content showing that perpetrator to be associated with the perpetrator data file. Once the user is done, the perpetrator data file is generated (block 124) and stored (block 126). That perpetrator data file can then be cross-indexed with crime incident data files, as described above.

At block 128, the system determines if the user has more crime incidents or perpetrators to report. If so, the method returns to block 112. If not, the method proceeds to block 130.

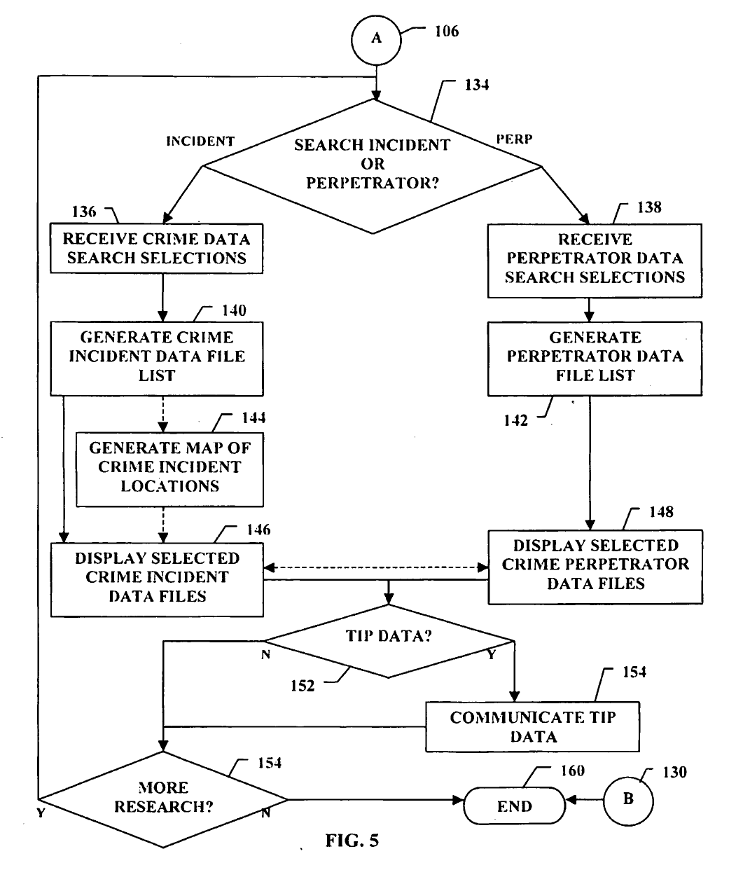

Referring to FIG. 5, after block 106 (continued from FIG. 3) the system 10 determines whether the user intends to search for crime incidents or crime perpetrators (block 134). If the user intends to search for crime incidents, the method proceeds to block 136. If the user intends to search from perpetrators, the method proceeds to block 138.

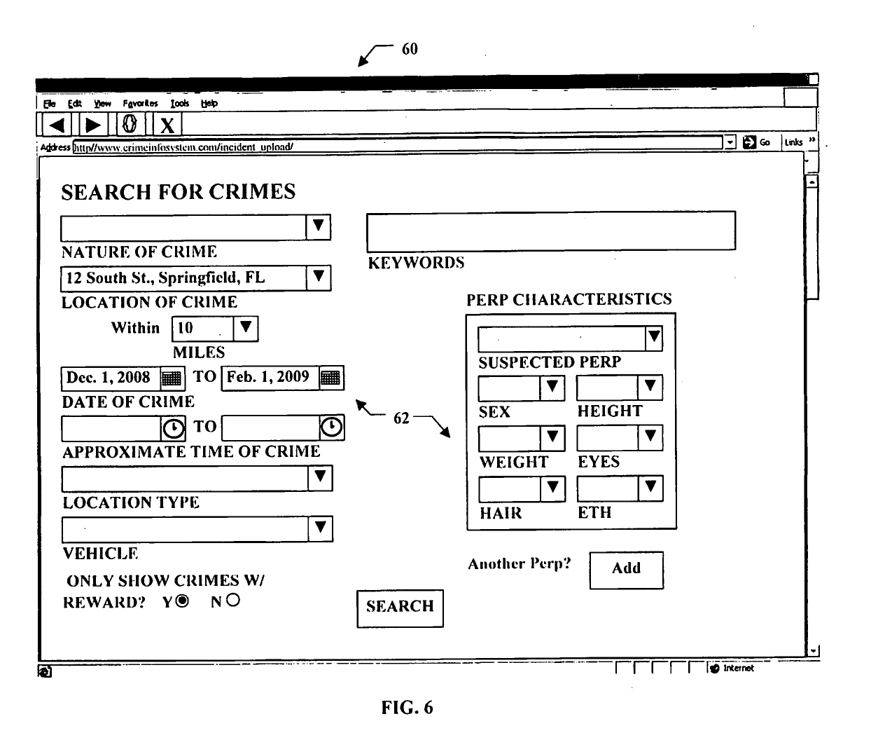

Referring to FIG. 6, in an exemplary crime incident data search screen 60, the user is displayed a plurality of crime data search options 62 that correspond to the crime data tag options 52. The user makes selections from as many options 62 as the user feels necessary to find only the crime incident data files potentially of interest to the user. A similar screen is displayed in connection with block 138 to select perpetrator data search options.

After the user is done and finalizes the search request, the system 10 generates a crime incident data file list (block 140), including a tabular form listing of crime incident data files with crime incident data tags matching the user's crime data search request. Following perpetrator search requests, a similar perpetrator data file list is generated (block 142).

Upon reviewing the crime incident data file list, the user can delete items that are not of interest and the system 10 can generate a map of the locations of the all crime incident data files remaining on the list (block 144), using information from the map database 40. The user can view any of the full crime incident data files, including viewing the media content and all data tag options selected by the corresponding crime reporting entity (block 146), by either selecting a location of the map or selecting a line item from the crime incident data file list.

Similarly, at block 148, the user can view any of the full perpetrator data files by selecting a line item from the perpetrator data file list. As the crime incident and perpetrator data files are cross-indexed, the user can select a perpetrator associated with a crime incident date file to see the full associated perpetrator data file, and vice versa.

At block 152, the system 10 determines if the user has any crime tip data about any view crime incident data files or perpetrator data files. If the perpetrator has tip data, the system 10 receives the data and communicates the tip data to the crime reporting entity(ies) 12 corresponding with the data file(s), as well as to any law enforcement entities having jurisdiction (block 154).

At block 156, the system 10 determines if the user intends to do more research. If so, the method returns to block 134. If not, the method ends at block 160. It will be appreciated that the method can be repeated as often as desired and that a given user can interact with the system 10 both for steps relating to a crime reporting entity 12 and a crime researching entity 14.

The present invention is not necessarily limited to a particular means of generating revenue, or to actually generating revenue. However, access can be freely provided to all entities, with revenue generated based on the sale of advertisements. Alternately, revenue can be supplied by the government, privately donated, a usage fee can be assessed, or any combination of the above.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A network-based crime information coordination system comprising:
a server, including a processor and machine readable memory, executing:
a crime data file generation module configured to receive crime incident media content over the network from crime reporting entities and generate crime incident data files by associating the media content with crime data tags;
a crime incident database storing the crime incident data files;
a crime data search module configured to receive crime data search requests over the network from crime researching entities and selectively display the crime incident data files from the crime incident database based on the crime data search requests.

2. The system of claim 1, wherein the crime data file generation module is further configured to receive security camera crime scene videos from the crime reporting entities.

3. The system of claim 1, wherein the crime data file generation module is further configured to display predetermined crime data tag options to the crime reporting entities and generate the crime data tags for association with the media content based on selections thereof.

4. The system of claim 3, wherein the predetermined crime data tag options include at least three of: location of crime, date of crime, time of crime, nature of crime, crime location type, perpetrator characteristics and reward information.

5. The system of claim 4, wherein the predetermined crime data tag options include location of crime and date of crime.

6. The system of claim 3, wherein the crime data search module is further configured to display predetermined crime data search options corresponding to the crime data tag options to the crime researching entities and generate the selectively display the crime incident data files based on the crime data search options selected.

7. The system of claim 1, wherein the crime data search module is further configured to receive crime tip data over the network from the crime researching entities relating to the crime incident data files.

8. The system of claim 7, wherein the crime data search module is further configured to communicate the crime tip data to the crime reporting entities.

9. The system of claim 7, wherein the crime data search module is further configured to communicate the crime tip data to law enforcement entities.

10. The system of claim 1, wherein the crime data search module is further configured to display crime incident data file lists indicating the crime incident data files that correspond to the crime data search requests.

11. The system of claim 10, wherein the crime data search module is further configured to receive selections of crime incident data files from the lists by the crime researching entities and display the crime incident data files selected.

12. The system of claim 10, wherein the crime data search module is further configured to generate maps of locations corresponding to the crime incident data files on the lists.

13. The system of claim 10, wherein the crime data search module is further configured to receive selections of the locations on the maps by the crime researching entities and display the crime incident data files corresponding to the locations selected.

14. The system of claim 1, wherein the crime data file generation module is further configured to receive perpetrator information over the network from the crime reporting entities and generate perpetrator data files by associating the perpetrator information with perpetrator data tags;
wherein the server further executes a perpetrator database storing the perpetrator data files; and
wherein the crime data search module is further configured to selectively display the perpetrator data files from the perpetrator database to the crime researching entities based on the crime data search requests.

15. The system of claim 14, wherein the crime incident database and the perpetrator database are cross-indexed.

16. A network-based crime information coordination method comprising:
receiving crime incident media content over the network from crime reporting entities;
receiving crime data tag selections corresponding to the crime incident media content over the network from the crime reporting entities;
generating crime incident data files including the crime incident media content and the corresponding crime data tags;
storing the crime incident data files in a crime incident database searchable over the network by crime researching entities.

17. The method of claim 16, further comprising:
receiving crime data search selections corresponding to the crime data tag selections over the network from the crime researching entities;
generating crime incident data file lists indicating crime incident data files in the crime incident database that correspond to the crime data search selections; and
displaying the crime incident data file lists to the crime researching entities over the network.

18. The method of claim 17, further comprising:
receiving selections over the network from the crime researching entities of the crime incident data files indicated on the crime incident data file lists; and
displaying the selected crime incident data files to the crime researching entities over the network.

19. A network-based crime information coordination method comprising:
maintaining a crime incident database of crime incident data files including crime data tags and crime media content;
receiving crime data search requests corresponding to the crime data tags from crime researching entities over the network;
displaying crime media content from crime incident data files corresponding to the crime data search requests to the crime researching entities over the network; and
receiving crime tip data relating to the displayed media content from the crime researching entities over the network.

20. The method of claim 19, further comprising communicating the crime tip data over the network to at least one of: crime reporting entities responsible for the crime media content and law enforcement entities.
